(19) United States
(12) Patent Application Publication
(10) Pub. No.: US 2017/0305135 A1
(43) Pub. Date: Oct. 26, 2017

(54) Method for Manufacturing a Customer-Specific Component of a Field Device

(71) Applicant: Endress + Hauser GmbH + Co. KG, Maulburg (DE)

(72) Inventors: Joachim Albert, Leonberg (DE); Detlev Wittmer, Maulbronn (DE); Marc Baret, Kembs (FR); Dietmar Spanke, Steinen (DE); Thomas Uehlin, Schopfheim (DE)

(21) Appl. No.: 15/513,285

(22) PCT Filed: Aug. 19, 2015
(86) PCT No.: PCT/EP2015/069073

§ 371 Date: Mar. 22, 2017

(30) Foreign Application Priority Data
Sep. 26, 2014 (DE) 10 2014 114 037.0

(51) Int. Cl. B33Y 10/00; B33Y 50/02; B22F 3/105; B29C 64/393

(52) U.S. Cl. CPC B33Y 10/00; B33Y 50/02; B22F 3/1055; B29C 64/393

(57) ABSTRACT

The invention relates to a method for manufacturing a customer-specific component of a field device for determining or monitoring at least one process variable of a medium, wherein the field device is applied in process automation technology, wherein the component is composed of at least one material, comprising: predetermining material and/or structure and/or shape of the component via digital description data, and producing the component in a 3D printing method in accordance with the predetermined digital description data.

The invention relates to a method for manufacturing a customer-specific component of a field device for determining or monitoring at least one process variable of a medium, wherein the field device is applied in process automation technology and is composed of at least one material. Preferably, however, not exclusively, the component is a replacement part, a conversion part or wear part.

Serving for registering process variables in automation technology are sensors, which are installed, for example, in fill level measuring devices, flow measuring devices, pressure- and temperature measuring devices, analytical measuring devices, etc. The devices register the corresponding processvariable, fill level, flow, pressure, temperature, analytical data, such as pH-value, turbidity, BOD, COD, TOC, SAC, ammonium, nitrate, nitrite, phosphate, aluminum, manganese, iron, chromate, silicate, copper, hardness, hydrazine, chlorine, sodium, arsenic, mercury, lead, cadmium or conductivity. Serving for influencing process variables are actuators, all such as, for example, valves or pumps, via which the flow of a liquid in a section of pipeline or the fill level in a container can be changed. Sensors and actuators are generally referred to as field devices. The terminology, field devices, in connection with the invention refers, however, to all devices, which are applied near to the process and deliver, or process, process relevant information. Field devices are usually composed of a plurality of components, whose structure and construction are embodied as simply as possible, in order to keep the manufacturing effort with conventional manufacturing methods as small as possible.

In order to avoid storage costs, components of field devices are manufactured as near as possible in time to the delivery of the field device. If a field device fails, the component responsible for the failure of the field device should be replaced immediately, in order that the downtime of the plant is as small as possible. To this end, operators of plants, in which the field devices are installed, keep an inventory of at least field device replacement parts important for operation of the plants. Since in a plant often field devices and their successor types are installed, the warehousing of replacement parts can, in giving cases, be quite significant. In order to reduce this storage effort on the part of the operator of the plant, it is often expected that the manufacturers of field devices will, in given cases, even years after the first installation of a field device, have a required replacement part in inventory and deliverable without delay. If the replacement parts can no longer be ordered, then they must be complexly produced in conventional production processes involving machining, for example. While in the previously mentioned case, high storage costs occur, there can be in the just related case, in given cases, inordinately high manufacturing costs and long delivery- and transport times, which likewise result in correspondingly high costs for the field device user. In the case of the field device manufacturers, requests for individual manufacture, in given cases, disturb the normal production flows. Moreover, eventually there can be disposal costs for the disposal of no longer required replacement parts. The conventional procedures naturally also involve burdens for the environment.

An object of the invention is to provide a method, in the case of which a component of a field device can be supplied near in time and cost effectively.

The object is achieved by a method comprising method steps as follows: predetermining material and/or structure and/or shape of the component via digital description data, producing the component in a 3D printing method in accordance with the predetermined digital description data. In connection with the invention, the terminology, 3D printing method, includes all generative manufacturing methods.

Preferably, the digital description data is won by steps including: specifying at least one structurally related and/or material related, boundary condition of the component and/or a boundary condition relevant to the functionality of the component and/or at least one external boundary condition, which takes into consideration influence of environmental conditions on the component at the location of use; optimizing the structure of the component via a finite elements model based on the at least one structurally related and/or material related, boundary condition and/or the at least one boundary condition relevant to the functionality of the component and/or the at least one environmental condition, wherein the optimized structure of the component is described by the digital description data, transferring the digital description data, which describes the optimized structure of the component, to a 3D printer; printing the component in accordance with the digital description data.

When the description data is available, then the corresponding component is produced by the manufacturer or the distributor of the field device and sent to the operator of the field device. Alternatively, the 3D printing of the component is performed by the operator of the field device, in given cases, by the customer. Especially, the description data is provided to the operator with costs, e.g. via the Internet. The operator of the plant, thus, takes a license and prints the component on-site.

In summary, according to the invention, the field device manufacturer especially no longer provides components as a part of a replacement parts business, but, instead, digital description data giving a 3D printer explicit instructions on how to print the component. In such case, the resolution of the structure of the component is matched to the resolution of the 3D printer, or the resolution of the 3D printer is so selected that the component can be printed with the required resolution.

Utilized are known generative manufacturing methods, e.g. 3D printing methods. If used as material is at least one metal or at least one plastic, then preferably a selective laser melting or a selective laser sintering is applied. If used as material is at least one metal, then applied as generative manufacturing method for the at least one metal can be the laser deposition welding method or the metal powder application method (MPA). If used as material is at least one plastic, then applied as generative manufacturing method for the at least one plastic can be fused deposition modeling or multi-jet modeling or ARBURG Plastic Freeforming (APF). If the material is at least one ceramic, then used as generative manufacturing method for the ceramic is Color Jet Printing (CJP). A component can be of different materials, which are processed together in a generative manufacturing process. Also, an option is to provide the material with a suitable porosity via a generative manufacturing process, e.g. a 3D printing process. A corresponding method is described in patent application DE 10 2014 114 016.8 of the applicant filed on the same original filing date as the present patent application. Especially provided in the parallel patent application are also examples of embodiments for the field of automation technology. The disclosure of such parallel patent application is explicitly included in the disclosure of the present patent application.

Field devices of automation technology must, in given cases, fulfill certain safety requirements. Therefore, it is provided according to an advantageous further development of the method of the invention that the at least one material, which is printed by the 3D printer, and/or the at least one 3D printer are/is certified. Certification allows the component to be used in automation technology.

The component manufactured via the 3D printing method is preferably a replacement part, a wear part or a conversion part for a field device. Likewise, the component can also be a custom-made product.

In order to assure that the digital description data including the certification provisions come from the manufacturer of the field devices or from an authorized representative, a coding is provided in the region of the connecting part of the component with a corresponding connecting part of the field device. This coding can be embodied country-, device parameter- and/or customer specifically. Preferably, the coding is uniquely embodied, so that the component is usable only in connection with the field device identifiable e.g. by a unique serial number. For example, the coding is a mechanical key, lock coding with e.g. differently placed locating pins, which have different forms and/or different lengths.

The following are some examples of components from the field of automation technology manufactured according to the method of the invention:
a freely radiating antenna for a radar measuring device based on the travel time principle, wherein the antenna of a conductive material has an insert or attachment of a non-conductive material,
a component having a seal, wherein component and seal are preferably manufactured of different materials,
a feedthrough of plastic, ceramic or glass for electrical lines with integrated electrical lines,
an electronics housing of plastic containing an EMC shielding,
a sensor bed having a separating membrane for a pressure sensor element,
a field device component coming in contact with a medium and having a protective coating in the surface region,
a field device component coming in contact with a medium and having a biocidal coating in the surface region,
a flange or a lengthening component.

Concerning the pressure sensor element composed of sensor bed and gap-freely printed, separating membrane, either the two components are created simultaneously in a printing process, or first the arbitrarily complex sensor bed and then the separating membrane printed in the edge region of the sensor bed. In both cases, the component has no joint gap. Therefore, a corresponding pressure sensor element manufactured with the 3D printing exhibits no hysteresis. In the case of a conventional manufacturing method, the joint is present, and the hysteresis problems must be taken into consideration.

The above components of field devices mentioned by way of example are sold by the companies of the E+H group either installed in field devices or as individual components.

The invention will now be explained in greater detail based on the appended drawing, the figures of which show as follows:

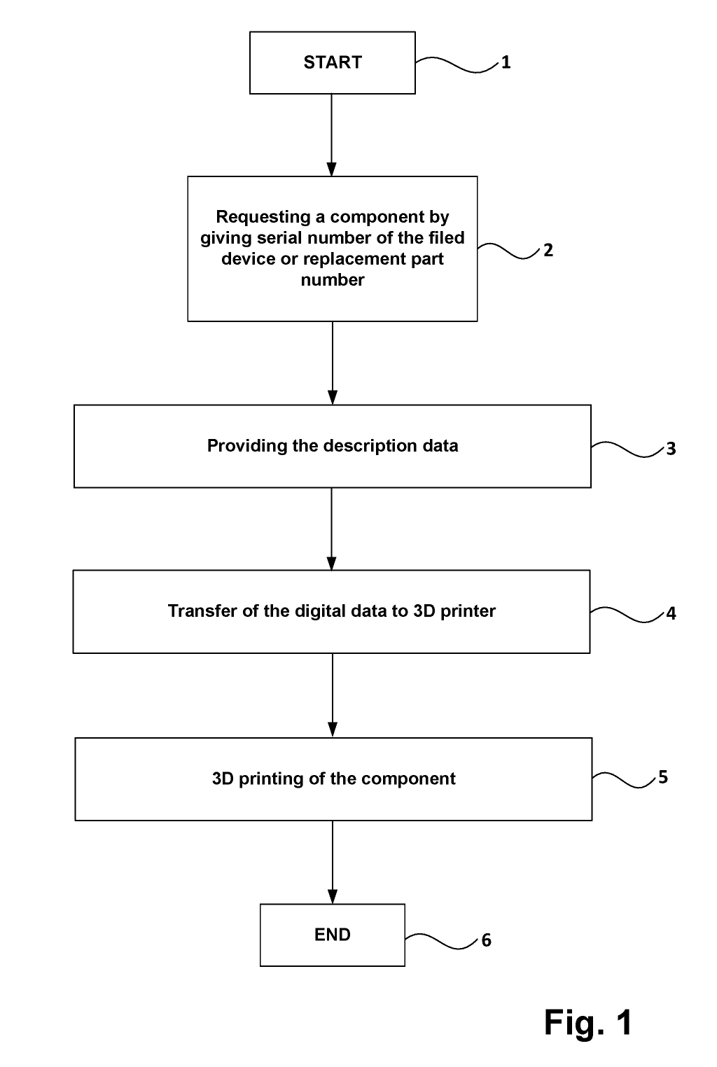

FIG. 1 a flow diagram of the method of the invention, and

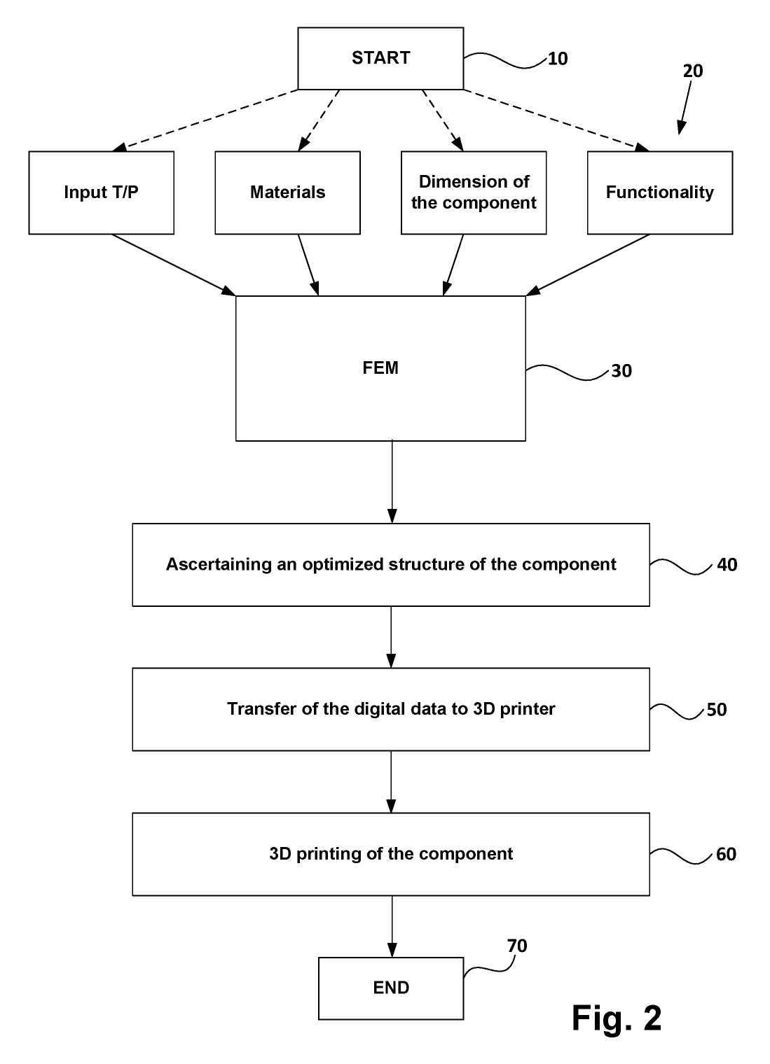

FIG. 2 a flow diagram for obtaining the description data.

FIG. 1 shows a flow diagram illustrating the method of the invention. At point 1 the method is started, and at point 2, the required component is specified. In such case, either reference is made to the serial number of the corresponding field device, or the component is directly characterized by giving its replacement part number. An appropriate e.g. mechanical coding is used to block unauthorized replication of the component. The requesting of the component occurs preferably per email or via an Internet access and a customer account at the field device manufacturer.

At point 3, the field device manufacturer or an authorized representative provides the digital description data of the component. At point 4, the component is printed by means of the digital description data. The 3D printing occurs either at the manufacturer's or supplier's site or on-site by the operator of the plant, thus at the customer's location.

At point 5, the component created in the 3D printing is installed in the field device or attached to the field device, as the case may be.

FIG. 2 schematically shows a flow diagram for obtaining the digital description data. After the start of the program at point 10, at point 20, the items of information necessary for the FEM modeling are input. In the illustrated case, these include the environmental parameters, temperature and pressure, which the component is exposed to at the location of use of the field device. In such case, it is, in principle, noted that the costs for materials become higher, the higher the requirements for temperature- and pressure resistance. In many cases, it is important, moreover, to specify the dimensions of the component, at least roughly. Important for simulating the component is then, naturally, the function, which the component should fulfill. Of course, once the digital description data has been generated, such can subsequently be used for the 3D printing of as many components as desired. Depending on application, it can also be sufficient to specify just the outer shape and the corresponding dimensions, e.g. in the case of a flange.

Based on the predetermined information, at the program points 30, 40, an optimized structure of the component is calculated via an FE model. The optimized structure of the component is described by digital description data. The creation of the optimized structure occurs especially in the case, in which the customer specifies particular requirements for the component places. The digital description data are transferred at program point 50 to a 3D printer, which prints the component at program point 60 in accordance with the digital data.

1-16. (canceled)

17. A method for manufacturing a customer-specific component of a field device for determining or monitoring at least one process variable of a medium, wherein the field device is applied in process automation technology, wherein the component is composed of at least one material, comprising the steps of:
predetermining material and/or structure and/or shape of the component via digital description data; and
producing the component in a 3D printing method, i.e. in a generative manufacturing method, in accordance with the predetermined digital description data.

18. The method as claimed in claim 17, wherein the digital description data are preferably won in the following way:
specifying at least one structurally related and/or material related, boundary condition of the component and/or a boundary condition relevant to the functionality of the component and/or at least one external boundary condition, which takes into consideration influence of environmental conditions on the component at the location of use;
optimizing the structure of the component via a finite elements model based on the at least one structurally related and/or material related, boundary condition and/or the at least one boundary condition relevant to the functionality of the component and/or the at least one environmental condition, wherein the optimized structure of the component is described by the digital description data;
transferring the digital description data, which describe the optimized structure of the component, to a 3D printer; and
printing the component in accordance with the digital description data.

19. The method as claimed in claim 17, wherein:
the component is produced by the manufacturer or the distributor of the field device and provided to the operator of the field device.

20. The method as claimed in claim 17, wherein:
the description data for manufacturing the components are provided by the manufacturer or the distributor of the field device; and
the 3D printing method is performed on-site by or for the operator of the field device.

21. The method as claimed in claim 17, wherein:
used as material is at least one metal or at least one plastic; and
a selective laser melting or a selective laser sintering is used as 3D printing method.

22. The method as claimed in claim 17, wherein:
used as material is at least one metal; and
applied as generative manufacturing method for the at least one metal is laser deposition welding or the metal powder application method (MPA).

23. The method as claimed in claim 17, wherein:
used as material is at least one plastic; and
fused deposition modeling or multi-jet modeling is applied as 3D printing method for the at least one plastic.

24. The method as claimed in claim 17, wherein:
used as material is at least one ceramic; and
color jet printing (CJP) is used as 3D printing method for the ceramic.

25. The method as claimed in claim 17, wherein:
the at least one material and/or the at least one 3D printer are/is certified, so that they/it are/is suitable for manufacturing a material- and/or pressure loaded component.

26. A component for a field device of automation technology, manufactured by a method for manufacturing a customer-specific component of a field device for determining or monitoring at least one process variable of a medium, wherein the field device is applied in process automation technology, wherein the component is composed of at least one material, comprising the steps of: predetermining material and/or structure and/or shape of the component via digital description data; and producing the component in a 3D printing method, i.e. in a generative manufacturing method, in accordance with the predetermined digital description data, wherein:
the component is a replacement part, a wear part or a conversion part for a field device.

27. The component as claimed in claim 26, wherein:
a coding is provided in the region of the connecting part of the component with a corresponding connecting part of the field device.

28. The component as claimed in claim 27, wherein:
the coding is embodied country, device parameter and/or customer specifically.

29. The component as claimed in claim 27, wherein:
the coding is uniquely embodied, so that the component is usable only in connection with the field device identifiable especially by a unique serial number.

30. The component as claimed in claim 27, wherein:
the coding is a mechanical key, lock coding.

31. The component as claimed in claim 26, wherein:
the component is manufactured of at least two different materials.

32. The component as claimed in claim 31, wherein the component is especially:
a freely radiating antenna for a radar measuring device based on the travel time principle, wherein the antenna of a conductive material has an insert or attachment of a non-conductive material;
a component having a seal, wherein component and seal are preferably manufactured of different materials;
a feedthrough of plastic, ceramic or glass for electrical lines with integrated electrical lines;
an electronics housing of plastic containing an EMC shielding;
a field device component coming in contact with a medium and having a protective coating in the surface region; and
a field device component coming in contact with a medium and having a biocidal coating in the surface region.
